(19) United States
(12) Patent Application Publication
(10) Pub. No.: US 2025/0089745 A1
(43) Pub. Date: Mar. 20, 2025

(54) SYSTEMS AND METHODS FOR OPERATING AN AUTOMATED COOKING APPARATUS

(71) Applicant: KITCHEM ROBOTICS LTD, Modiin (IL)

(72) Inventors: OFER ZINGFER, Demarest, NJ (US); Yair Gordin, Modiin (IL); David Ben-David, Rehovot (IL)

(73) Assignee: KITCHEN ROBOTICS LTD, Modiin (IL)

(21) Appl. No.: 18/368,264

(22) Filed: Sep. 14, 2023

(51) Int. Cl. A23L 5/10; A47J 36/32; A47J 44/00; G06N 20/00

(52) U.S. Cl. CPC A23L 5/10; A47J 36/321; A47J 44/00; G06N 20/00

(57) ABSTRACT

There is provided a computer implemented method of operating an automated cooking apparatus, comprising: in at least one iteration: receiving, via an interactive chat session between a chatbot and a client terminal, at least one personal preference parameter for automated preparation of a dish by the automated cooking apparatus, feeding a plurality of parameters including the at least one personal preference parameter into a machine learning model, and obtaining as an outcome of the machine learning model, structured instructions for execution by the automated cooking apparatus for automatically preparing at least one dish, wherein the structured instructions comply with the at least one personal preference parameter, wherein the structured instructions for automatically preparing the at least one dish are dynamically adapted according to the at least one personal preference parameter obtained via the interactive chat session.

### BACKGROUND

The present invention, in some embodiments thereof, relates to a chatbot and, more specifically, but not exclusively, to a chatbot for operating an automated cooking apparatus.

Restaurant chatbots serve the purpose of automating various tasks typically handled by human staff, such as reservation bookings. Their skillset varies based on the specific use case they are deployed for. Some chatbots are equipped with machine learning capabilities, allowing them to understand user intent and provide personalized gastronomic recommendations based on their interactions with customers. Conversely, rule-based chatbots with more restricted artificial intelligence (AI) capabilities can efficiently handle tasks like addressing frequently asked questions (FAQs) from clients or sending out mass notifications regarding events.

### SUMMARY

According to a first aspect, a computer implemented method of operating an automated cooking apparatus, comprises: in at least one iteration: receiving, via an interactive chat session between a chatbot and a client terminal, at least one personal preference parameter for automated preparation of a dish by the automated cooking apparatus, feeding a plurality of parameters including the at least one personal preference parameter into a machine learning model, and obtaining as an outcome of the machine learning model, structured instructions for execution by the automated cooking apparatus for automatically preparing at least one dish, wherein the structured instructions comply with the at least one personal preference parameter, wherein the structured instructions for automatically preparing the at least one dish are dynamically adapted according to the at least one personal preference parameter obtained via the interactive chat session.

According to a second aspect, a system for operating an automated cooking apparatus, comprises: at least one processor executing a code for: in at least one iteration: receiving, via an interactive chat session between a chatbot and a client terminal, at least one personal preference parameter for automated preparation of a dish by the automated cooking apparatus, feeding a plurality of parameters including the at least one personal preference parameter into a machine learning model, and obtaining as an outcome of the machine learning model, structured instructions for execution by the automated cooking apparatus for automatically preparing at least one dish, wherein the structured instructions comply with the at least one personal preference parameter, wherein the structured instructions for automatically preparing the at least one dish are dynamically adapted according to the at least one personal preference parameter obtained via the interactive chat session.

In a further implementation form of the first and second aspects, during the at least one iteration, receiving comprises receiving an adaptation of at least one personal preference parameter provided in a preceding iteration, and dynamically adapting the structured instructions for preparing an adaptation of the at least one dish according to the adaptation of the at least one personal preference parameter.

In a further implementation form of the first and second aspects, the plurality of parameters include at least one constraint parameter for preparation of the at least one dish, wherein the structured instructions comply with the at least one constraint parameter, and further comprising: analyzing the at least one personal preference parameter in view of the at least one constraint parameter, and in response to the analysis indicating that the at least one constraint parameter is not met, adapting the interactive chat session for obtaining an adaptation of the at least one personal preference parameter that meets the at least one constraint parameter.

In a further implementation form of the first and second aspects, the at least one constraint includes at least one of: capability of the automated cooking apparatus, ingredients available for use by the automated cooking apparatus, cooking actions performed by the automated cooking apparatus, maximum time to prepare the at least one dish by the automated cooking apparatus, and target range for cost for production of the at least one dish by the automated cooking apparatus.

In a further implementation form of the first and second aspects, the at least one personal preference parameter includes at least one of: type of cuisine, allergy to at least one ingredient of the at least one dish, preference for a certain ingredient for inclusion in the at least one dish, dislike of the certain ingredient for exclusion from the at least one dish, amount of the certain ingredient to include in the at least one dish, compliance with dietary religious laws, and low calorie and/or low fat and/or low carbohydrate preference.

In a further implementation form of the first and second aspects, during a current iteration, the interactive chat session presents a message for obtaining another at least one personal preference parameter according to an analysis of at least one personal preference parameter obtained in a preceding iteration.

In a further implementation form of the first and second aspects, the at least one iteration terminates upon at least one of: user input indicating termination, and convergence of the plurality of parameters.

In a further implementation form of the first and second aspects, convergence comprises at least one of: no more remaining parameters for selection by a user while meeting constraints of other parameters, generating a number of dishes less than a threshold, and diversity of dishes being less than a threshold.

In a further implementation form of the first and second aspects, the at least one personal preference parameter of a current iteration is selected for at least one of: providing another possible option of a variation of the at least one dish, reducing the number of dishes, and reducing diversity of the dishes, generated by the machine learning model in comparison to a preceding iteration.

In a further implementation form of the first and second aspects, further comprising converting the structured instructions into human readable form, and presenting the human readable form on a display of the client terminal.

In a further implementation form of the first and second aspects, the plurality of parameters that are fed into the machine learning model include at least one dynamic parameter indicating a real time value for a time interval.

In a further implementation form of the first and second aspects, further comprising, during the at least one iteration: obtaining structured instructions for a plurality of dishes as the outcome of the ML model, and dynamically adapting a customized menu presented within a web accessible graphical user interface (GUI) presented on a display of a client terminal, the GUI configured for ordering at least one dish of the plurality of dishes from the menu via the client terminal.

In a further implementation form of the first and second aspects, further comprising automatically creating a landing webpage that includes the GUI of menu for hosting by a web server accessible by a plurality of client terminals.

In a further implementation form of the first and second aspects, further comprising, during the at least one iteration: extracting a plurality of features from the structured instructions for preparation of the at least one dish, feeding the plurality of features into an automated image generation model for automatically creating at least one image representing a visual prediction of the at least one dish after preparation by the automated cooking apparatus, and dynamically updating the automatically created image according to the at least one personal preference parameter.

In a further implementation form of the first and second aspects, the machine learning model is trained on a training dataset comprising a plurality of records, wherein a record comprises a sample plurality of parameters, and a ground truth of structured instructions for execution by the automated cooking apparatus for automatically preparing at least one sample dish.

In a further implementation form of the first and second aspects, the sample plurality of parameters include sample values for at least one personal preference parameter.

In a further implementation form of the first and second aspects, the plurality of parameters include at least one dynamic parameter that varies over time, wherein a current value of the at least one dynamic parameter corresponding to a time interval of the interactive chat session is fed into the machine learning model.

In a further implementation form of the first and second aspects, the at least one dynamic parameter includes at least one of: cost of ingredients used in preparation of the at least one dish, availability of ingredients for preparation of the at least one dish, time of day, day of week, season of year, and geographical location.

In a further implementation form of the first and second aspects, the automated cooking apparatus comprises a robotic kitchen configured to perform a plurality of different actions on a plurality of different ingredients for preparation of a plurality of different dishes, the plurality of different actions selected from: adding a predefined measure of a certain ingredient, cutting, mixing, stirring, and cooking, wherein the structured instructions define a sequence and/or a combination based on the plurality of different actions and based on the plurality of different ingredients for preparation of the at least one dish.

In a further implementation form of the first and second aspects, further comprising in response to instructions received from the client terminal, providing the structured instructions for execution by the automated cooking apparatus for automatically preparing the at least one dish.

In a further implementation form of the first and second aspects, further comprising: automatically preparing the at least one dish by the automated cooking apparatus executing the structured instructions.

In a further implementation form of the first and second aspects, further comprising: obtaining feedback from the user indicating a rating of the at least one dish automatically prepared by the automated cooking apparatus executing the structured instructions, automatically creating a new record including the plurality of parameters including the at least one personal preference, a ground truth of the structured instructions obtained as the outcome of the machine learning model, and the rating, and updating the machine learning model for creating structured instructions for preparing dishes likely to be associated with a high rating.

According to a third aspect, a computer implemented method of training a machine learning model, comprises: for each sample dish of a plurality of sample dishes automatically prepared by an automated cooking apparatus: obtaining a plurality of parameters including at least one personal preference parameter, creating a record comprising the plurality of parameters and a ground truth including structured instructions executed by the automated cooking apparatus for preparing the sample dish, and training the machine learning model on a plurality of records for the plurality of sample dishes.

In a further implementation form of the third aspect, the record further comprises at least one dynamic parameter and an indication of the time interval.

In a further implementation form of the third aspect, wherein at least one parameter of the plurality of parameters of the record indicates capability of the automated cooking apparatus.

In a further implementation form of the third aspect, at least one parameter of the plurality of parameters of the record indicates at least one constraint for preparing the sample dish.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for automatically generating instructions for operating an automated cooking apparatus according to one or more personal parameters obtained from a client terminal, in accordance with some embodiments of the present invention;

FIG. 2 is a flowchart of a method of automatically generating instructions for operating an automated cooking apparatus according to one or more personal parameters obtained from a client terminal, in accordance with some embodiments of the present invention;

FIG. 3 is a flowchart of a method of training a machine learning model for automatically generating instructions for operating an automated cooking apparatus according to one or more parameters including personal parameter(s) obtained from a client terminal, in accordance with some embodiments of the present invention;

FIG. 4 is a schematic of a GUI running an interactive chat session for obtaining personal preference parameters from automated preparation of a dish by an automated cooking apparatus, in accordance with some embodiments of the present invention; and

FIG. 5 is another schematic of another GUI running an interactive chat session for obtaining personal preference parameters from automated preparation of a dish by an automated cooking apparatus, in accordance with some embodiments of the present invention.

### DETAILED DESCRIPTION

The present invention, in some embodiments thereof, relates to a chatbot and, more specifically, but not exclusively, to a chatbot for operating an automated cooking apparatus.

An aspect of some embodiments of the present invention relates to a system, a method, a computing device, and/or code instructions (stored on a data storage device and executable by one or more processors) for operating an automated cooking apparatus, optionally a kitchen robot, for generation of a customized dish. During each iteration of one or more iterations, inputs are obtained through an interactive chat session. The inputs include at least one personal preference parameter for automated preparation of a customized dish, for example, type of cuisine to prepare, specific ingredient to include, specific diet to cater to, specific ingredients to avoid (e.g., due to allergy), amount of specific ingredient, and the like. The chat session may be between a chatbot and a client terminal, which may be used by a user for ordering the customized dish. Multiple parameters, inclusive of the aforementioned personal preference parameter, are fed into a machine learning model. The machine learning model generates a set of structured instructions for execution by the automated cooking apparatus for the autonomous preparation of one or more customized dishes. The structured instructions comply with the personal preference parameter(s) provided by the client terminal, such that the customized dish created by the automated cooking apparatus executing the structured instructions satisfies the personal preference parameters (e.g., selected by the user).

The instructions formulated by the machine learning model may exhibit dynamic adaptability. This adaptability may be influenced by the personal preference parameter(s) obtained via the interactive chat session over one or more iterations and/or which may be predefined (e.g., obtained for a previous dish and/or stored on a data storage device). The structured instructions for the automated preparation of the dish(es) may be adjusted according to the personal preference parameter(s) dynamically obtained and/or adapted during the iterations of the interactive chat session. Each iteration may include a question or request for information made by the chatbot, and a response and/or selected provided by the user. This iterative process may help ensure that the automated cooking apparatus automatically creates customized dishes that align with and/or cater to the user's specific preferences, as communicated through the interactive chat session, while ensuring that the customized dishes may be prepared using the available hardware of the automated cooking apparatus.

As used herein, the term recipe (of a dish) may refer to the one or more parameters described herein, which may be obtained from the user (e.g., personal preference parameters), and/or may be pre-defined. For example, ingredients, and/or steps of preparation such as mixing, and/or cooking (e.g., time, temperature). The parameter(s) of the recipe may be fed into the ML model as described herein. The recipe may refer to the parameter(s) themselves, and/or to a human readable format of the generated instructions for operating the automated cooking apparatus for automatic preparation of a dish. For example, the user may provide a recipe via the chatbot, may view the recipe automatically created by the ML model (e.g., in human readable format), and/or may edit one or more parameters of the recipe such as change ingredients and/or cooking times.

An aspect of some embodiments of the present invention relates to a system, a method, a computing device, and/or code instructions (stored on a data storage device and executable by one or more processors) for training a machine learning model for automatically generating instructions for execution by an automated cooking apparatus for preparation of a dish, in response to an input of parameters, which include one or more personal preference parameter(s) of a user. For each sample dish of multiple sample dishes automatically prepared (or suitable for being automatically prepared) by an automated cooking apparatus, multiple parameters including at least one personal preference parameter (or suitable for serving as personal preference parameter(s)), are obtained. A training dataset of multiple records is created. A record including the parameters and a ground truth including structured instructions executed by the automated cooking apparatus for preparing the sample dish, is created. The machine learning model may be trained on multiple records of multiple sample dishes.

At least some embodiments described herein address the technical problem of operating an automated cooking apparatus, and/or improving a user experience in operating an automated cooking apparatus, for example, a kitchen robot. At least some embodiments described herein improve the technology of chatbots and/or machine learning models, by providing a chatbot and/or machine learning model for operating the automated cooking apparatus according to one or more parameters provided by a user via the chatbot. At least some embodiments described herein improve upon traditional approaches of operating the automated cooking apparatus.

The automated cooking apparatus may be a kitchen robot, also known as a cooking robot or a culinary robot, which is an automated machine designed to assist with various tasks in the kitchen. These robots may be equipped with technologies such as computer vision, and precise mechanical movements to perform specific culinary functions. They aim to streamline and simplify cooking processes, saving time and effort for users.

Some common features and capabilities of kitchen robots include:
(1) Food preparation: Kitchen robots can chop, slice, dice, and mix ingredients with precision and consistency, eliminating the need for manual cutting and reducing the risk of accidents.
(2) Cooking: Some advanced kitchen robots can cook dishes by controlling temperature, timing, and other cooking parameters. They can perform tasks like frying, steaming, baking, and grilling.
(3) Recipe assistance: Many kitchen robots come with built-in recipe databases or access to online recipe libraries. Recipes may be manually created by a chef. Users can select a recipe, and the robot will guide them through the preparation steps.
(4) Customization: Users can often adjust settings and preferences to suit their taste and dietary requirements. This includes adjusting cooking times, ingredient quantities, and spice levels.
(5) Precisely collecting (e.g., weighting) dry foods, liquid, and/or powder ingredients.

Kitchen robots cater to a wide range of users, from professional chefs looking for precise and consistent results to home cooks seeking convenience and support in their culinary endeavors. Kitchen robots may be associated with one or more physical restaurants and/or virtual restaurants, which may server various cuisines, for example, Cuban, Italian, Mexican, Asian, salads, and the like. The kitchen robots may serve the various cuisines using a single setup, for example, switching between different cuisines for different customers using the same setup.

Using existing approaches, operating the automated cooking apparatus (e.g., kitchen robot) requires a chef and/or an operator. The chef manually designs a recipe, and then writes instructions for the automated cooking apparatus for automatically preparing the dish. The operator may operate the automated cooking apparatus.

At least some embodiments described herein address the aforementioned technical problem(s), and/or improve the aforementioned technical field(s), and/or improve upon the aforementioned prior approaches, by providing a chatbot which iteratively receives personal preference parameters from a user via an interactive chat session, for example, culinary type preference, allergies, preference for certain ingredients and/or dislike of certain ingredients. The parameters are fed into a model (e.g., machine learning) which automatically generates instructions for the automated cooking apparatus for automatically preparing one or more dishes that satisfy the personal preference parameters of the user. The automated cooking apparatus may be used by a physical restaurant where diners order and eat in or get takeout, and/or by a virtual restaurant where users may order from a website. A menu, which presents multiple different dishes, is necessarily required, since parameters (e.g., recipe, personal preference parameters) entered by a user may be converted automatically to instructions for execution by the automated cooking apparatus for automatically preparing a dish. The chatbot may be used to iteratively and/or dynamically assist the user in planning recipe for a dish that is personalized to their needs. The dish may be prepared by converting (e.g., using the ML model) the recipe (e.g., in human readable form) to instructions for operating the automated cooking apparatus. A chef is not necessarily needed, since automated cooking apparatus is able to generate a decent edible dish, optionally using instructions automatically generated by the ML model based on the personal preference(s) of the user. In the generation of the instructions, the ML model may automatically take into account one or more constraints for preparation of the dish(es), for example, physical limitation of the automatic cooking apparatus, cost of the dish, maximum preparation time, and the like. In another example, the ML model may be instructions to prepare a “surprise” dish, without the user indicating specific parameters. The ML model may take into account taste preferences of the user, for example, for specific ingredients and/or type of cuisine. Versatility of the automated cooking apparatus is increased, since using the chatbot, the same automated cooking apparatus may be used to prepare different dishes for different users according to their personal preferences. The chatbot and/or ML model may dynamically adapt to changes in dynamic parameters, for example, availability of ingredients, by dynamically creating the instructions for the automated cooking apparatus according to current values of the dynamic parameters. An operator is not necessarily required, since the ML model may create optimized instructions which are automatically executed by the automated cooking apparatus.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

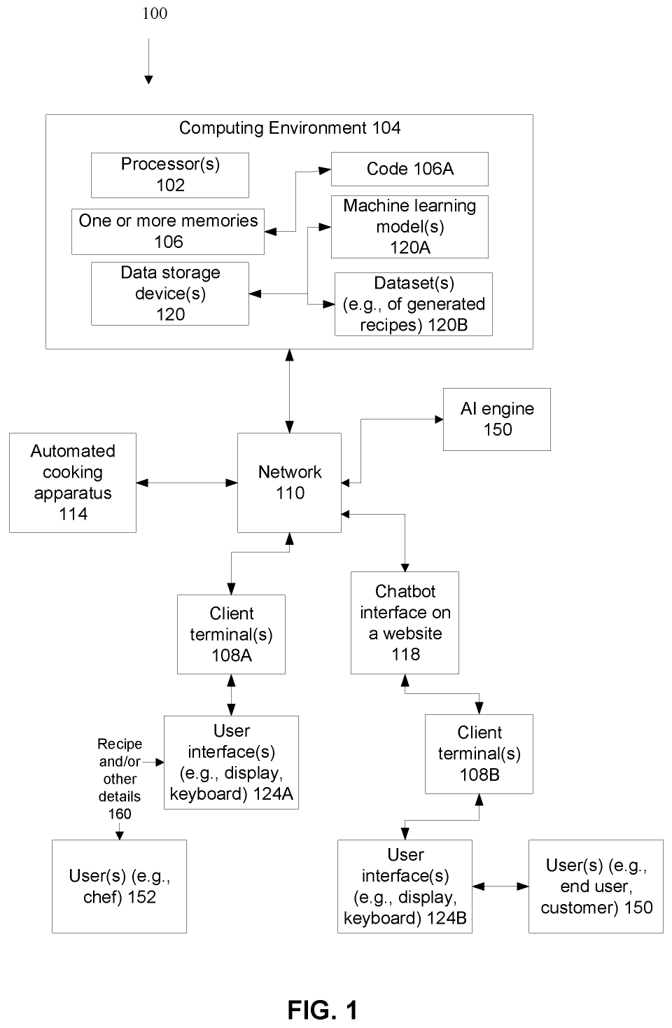

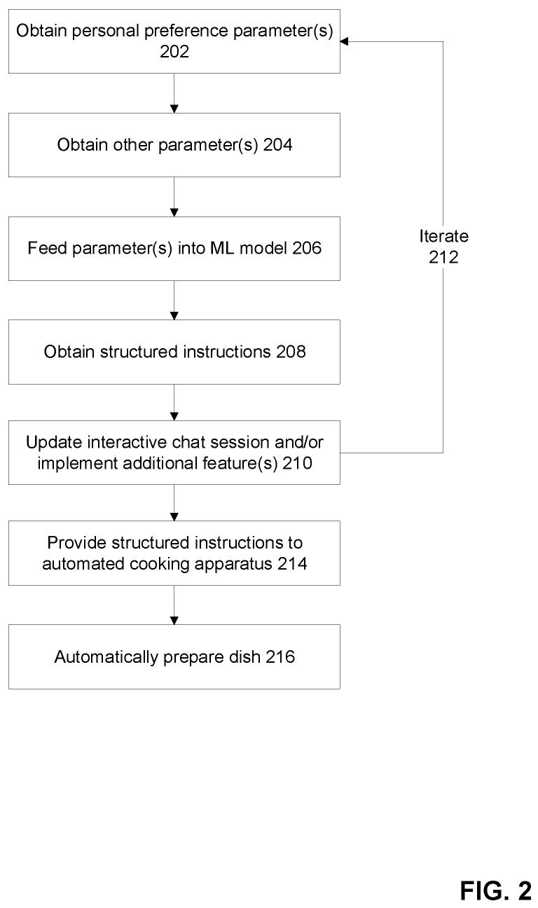

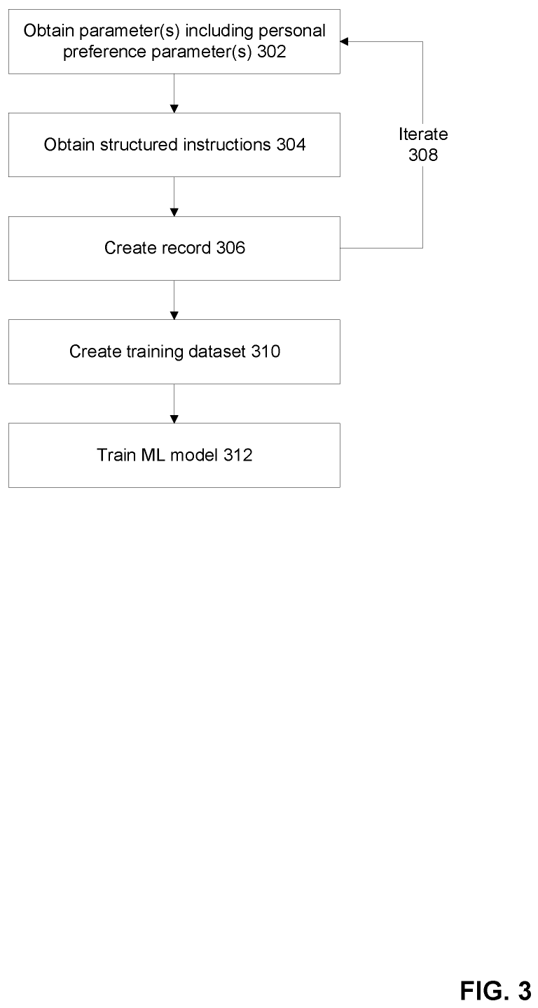

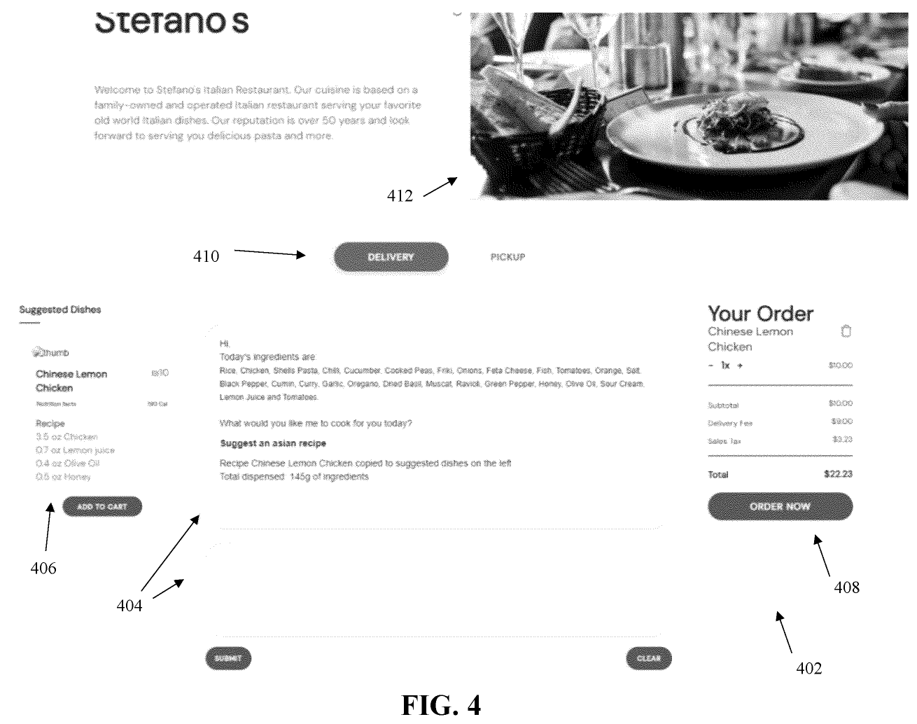

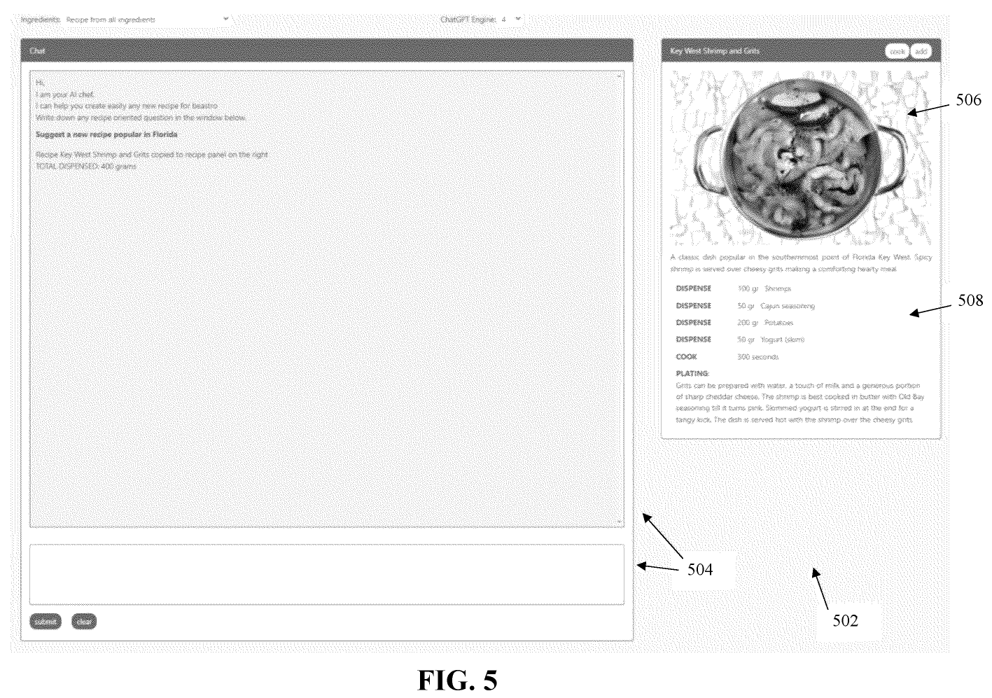

Reference is now made to FIG. 1, which is a block diagram of components of a system 100 for automatically generating instructions for operating an automated cooking apparatus according to one or more personal parameters obtained from a client terminal, in accordance with some embodiments of the present invention. Reference is also made to FIG. 2, which is a flowchart of a method of automatically generating instructions for operating an automated cooking apparatus according to one or more personal parameters obtained from a client terminal, in accordance with some embodiments of the present invention. Reference is also to FIG. 3, which is a flowchart of a method of training a machine learning model for automatically generating instructions for operating an automated cooking apparatus according to one or more parameters including personal parameter(s) obtained from a client terminal, in accordance with some embodiments of the present invention. Reference is also made to FIG. 4, which is a schematic of a graphical user interface (GUI) 402 running an interactive chat session for obtaining personal preference parameters from automated preparation of a dish by an automated cooking apparatus, in accordance with some embodiments of the present invention. Reference is also made to FIG. 5, which is another schematic of another GUI 502 running an interactive chat session for obtaining personal preference parameters from automated preparation of a dish by an automated cooking apparatus, in accordance with some embodiments of the present invention.

System 100 may implement the features of the method described with reference to FIGS. 2-3, by one or more hardware processors 102 of a computing environment 104 executing code instructions 106A stored in a memory (also referred to as a program store) 106.

In one example, a user 152 may be, for example, a chef with domain knowledge, may manually input recipe and/or other details 160 such as ingredients, steps, cooking times, and other relevant details. The automatic cooking apparatus may be operated according to the recipe to create one or more dishes. Chef 152 may access user interface 124A (which may be running on client terminal 108A), for accessing computing environment 104. Using user interface 124A, chef 152 may, for example, create/modify recipes and/or menus, define the cost, define the allowed recipe modifications (for example: allowed to remove onions or swap chicken with tofu), define ingredients, define the robot setup-which ingredient is associated to which dispenser and so on. Chef 152 may use user interface 124A, for manually enter the structured instructions for operating automated cooking apparatus 114, and/or the input provided by chef 152 may be automatically converted to the structured instructions. For example, chef 152 may write the recipe like a program in a special language, and a compiler may convert the recipe program to the instructions. The recipes created by chef 152 may be stored in a dataset(s) 120B, such as for use by end users such as customers wishing to order a dish. The recipes created by the chef may be included in training dataset(s) for training a machine learning model 120A for automatically creating structured instructions, as described herein.

In another example, a user 150 may be an end user (e.g., customer wishing to order a customized dish). Customer 150 may access a chatbot 118, which may be running on a website hosted by a web server, for example, a server of a restaurant. Customer 150 may use a use interface 124B of a client terminal 108B to access chatbot 118, for example, via a network connection (e.g., over network 110). Chatbot 118 may be hosted by other devices, for example, by computing environment 104. Chatbot 118 may present generated recipes of customized dishes to end user 150 on interface 124B. End user 150 may interact with chatbot 118 by entering input, for example, queries and/or by providing responses to messages presented by chatbot 118, optionally iteratively, as described herein.

Chatbot 118 may communicate with computing environment 104, for example, via an interface (e.g., application programming interface (API), software development kit (SDK)), for sending requests, user inputs, and/or other data. Chatbot 118 may receive a response from computing environment 104, for example, a recipe automatically generated by computing environment 104 based on inputs provided by chatbot 118 from end user 150 and/or chef 152.

Computing environment 104 receives parameters described herein from one or more of: entered by a user via chatbot 118, a specific automated cooking apparatus 114, client terminal 108A-B, and others, as described herein.

There may be one or more ML models which may be running on processor(s) 102 of computing environment 104 and/or running on an external device (e.g., within another computing cloud, and/or another server which is being accessed by computing environment 104 over network 110). In an example architecture, a single ML model may implemented ML model 120A and AI engine 150, by be fed parameters for obtaining an outcome of the structured instructions, and for generating data for presentation by the chatbot in response to user data entered via the chatbot. The single ML model may be hosted by computing environment 104 and/or by an external server. In another example, there may be two ML models; ML model 120A for generating structured instructions in response to an input of parameters (e.g., neural network), and AI engine 150 for generating data for presentation by the chatbot (e.g., a generative language model). AI engine 150 may be implemented, for example, as a generative language model. ML model 120A may be hosted by computing environment 104, and AI engine 150 may be hosted by an external server.

Computing environment 104 may send parsed data (e.g., requests, inputs) and/or the parameter(s) to AI engine 150 and/or ML model 120A. The request may be transmitted over an API call to the AI engine's hosting server and/or to computing environment 104 hosting the ML model. AI engine 150 and/or ML model 120A may process the received input, understand context, and generate a response (structured instructions for execution by automated cooking apparatus 114 and/or response to be presented by chatbot 118). The generated response may be sent back to computing environment 104, optionally to a logic server layer of a server implementation.

Alternatively or additionally, the parameters are used to create new records of a training dataset for training and/or updating machine learning model 120A. Data for creation of new records and/or updating of existing records of the training dataset may be obtained from multiple different automated cooking apparatuses 114, from multiple different sample client terminals 108A-B, and/or other sources as described herein.

Multiple architectures of system 100 based on computing environment 104 may be implemented. In an exemplary implementation, computing environment 104 may be implemented as one or more servers (e.g., network server, web server, a computing cloud, a virtual server) that provides centralized services to multiple client terminals 108B accessing chatbot 118. Client terminals 108B may be located at different geographical locations. There may be one or more different automated cooking apparatuses 114 for preparation of dishes using instructions generated in response to data provided by respective client terminals 108 to chatbot 118. Automated cooking apparatus 114 and/or client terminal(s) 108B may directly communicate with computing environment 104 acting as the server over network 110, and/or may indirectly communicate with the server using an intermediary device.

Alternatively, in a local implementation, computing environment 104 may be implemented as a component within automated cooking apparatus 114, for example, as a controller and/or card and/or circuitry installed within the housing of automated cooking apparatus 114. In the local implementations, the local computing environment 104 may access a locally stored chatbot 118 and/or machine learning model 120A. Machine learning model may be locally trained using data associated with the specific automated cooking apparatus 114.

In another local implementation, computing environment 104 may be an external device that is in local communication with automated cooking apparatus 104, for example, computing environment 104 is a mobile device (e.g., smartphone, laptop, watch computed) connected to automated cooking apparatus 114, for example, by a cable (e.g., USB) and/or short-range wireless connection. In such implementation, each computing environment 104 may be associated with a single or small number of automated cooking apparatus 114, for example, a user uses their own smartphone to connect to their own automated cooking apparatus. The computing environment 104 may serve as the controller of the automated cooking apparatus.

Automated cooking apparatus 114 may be implemented as, for example, a robotic kitchen system capable of handling complex cooking tasks, for example, chopping, mixing, and/or cooking ingredients as per a selected programmed recipe, to create a ready to eat dish.

Automated cooking apparatus 114 may include and/or be in communication with one or more of the following exemplary components: programmable logic controller (PLC), control logic, interface to computing environment 104 (e.g., API, SDK), cooking appliances for performing the cooking tasks, and actuators and/or such as for operation of the appliances, moving ingredients between different appliances, and the like. The PLC may communicates with the server (e.g., via TELNEL communication protocol, or another protocol such as HTTPS). There may be a layer on computing environment 104 (e.g., server) that includes the ML model logic and/or another layer for communicating with the PLC. The communication may be based on a certain API. Computing environment 104 (e.g., server) may send commands to the PLC, such as “turn on cooker”, and may call for example, for feedbacks and/or system status, to obtain hardware status of the system, for example sensors state, motors positions, etc. The PLC may provide outputs of sensors, system data, and/or other feedback, to the computing environment 104 and/or client terminal 108B (e.g., to user 150). For example, a specific API establishes a connection (e.g., TELNET) between PLC and layer 2 logic of the computing environment 104.

Computing environment 104 may be implemented as, for example, a computing cloud, a server, a virtual machine, a virtual server, a computing cloud, a client terminal, a mobile device, a desktop computer, a thin client, a Smartphone, a Tablet computer, a laptop computer, a wearable computer, glasses computer, and a watch computer.

Processor(s) 102 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units.

Memory 106 stores code instructions executable by hardware processor(s) 102. Exemplary memories 106 include a random-access memory (RAM), read-only memory (ROM), a storage device, non-volatile memory, magnetic media, semiconductor memory devices, hard drive, removable storage, and optical media (e.g., DVD, CD-ROM). For example, memory 106 may store code 106A that execute one or more acts of the method described with reference to FIGS. 2-3.

Code 106A may include one or more layer logics, for example, a first layer and a second layer. The first layer may implement ML logic, that may represent a decision point to indicate whether to use output of ML model 120A hosted by computing environment 104, or whether to call AI engine 150 hosted by an external server. The second layer may include, for example, a logic engine, logic to manage dataset(s) 120B, and a connection interface (e.g. API) to link with hardware of automated cooking apparatus 114 (e.g., via a TELNET session established between the second layer and the PLC of automated cooking apparatus 114).

Code 106A may perform one or more functions, for example, parsing the data entered by a user via chatbot 118 (e.g., requests), adding user parameterization, learning (e.g., creating training dataset(s) and/or training ML model(s) 120A), parsing responses of AI engine 150, formulating prompts and/or context-setting message based on user preferences, available ingredients, and/or other parameters relevant to recipe recommendations, for example, as described herein.

Computing environment 104 may include a data storage device 120 for storing data, for example, machine learning model 120A (e.g., trained on the training dataset), and/or the training dataset and/or chatbot 118. Data storage device 120 may host dataset(s) 120B, for example, of generated recipes, such as structured instructions automatically created by ML model(s) 120A and/or manually created by user 150 (e.g., chef) and/or customized by other users (e.g., customers). Data storage device 120 may be implemented as, for example, a memory, a local hard-drive, a removable storage device, an optical disk, a storage device, and/or as a remote server and/or computing cloud (e.g., accessed over network 110). It is noted that code 120A may be stored in data storage device 120, with executing portions loaded into memory 106 for execution by processor(s) 102.

One or more components of system 100 (e.g., computing environment, client terminal(s) 108A-B, automated cooking apparatus 114) may include one or more network interfaces (not shown), for connecting to network 110, for example, one or more of, a wire connection (e.g., physical port), a wireless connection (e.g., antenna), a network interface card, a wireless interface to connect to a wireless network, a physical interface for connecting to a cable for network connectivity, and/or virtual interfaces (e.g., software interface, application programming interface (API), software development kit (SDK), virtual network connection, a virtual interface implemented in software, network communication software providing higher layers of network connectivity).

Network 110 may be implemented as, for example, the internet, a local area network, a virtual network, a wireless network, a cellular network, a local bus, a point-to-point link (e.g., wired), and/or combinations of the aforementioned.

Computing environment 104 may communicate with one or more of the following over network 110:
Automated cooking apparatus(s) 114 for sending the structured instructions for preparation of the dish, automatically generated as an outcome of ML model 120A, and/or for automatically obtaining output of sensor(s) such as to obtain parameters to feed into the ML model 120A for generating structured instructions and/or for generating training dataset(s).
Chatbot 118, which may be hosted by a web server(s), such as of a restaurant.
A storage device storing personal preference parameters 108B of one or more users, which may have been obtained during one or more previous session by the users and/or obtained from sensor(s) and/or other sources. The personal preference parameters may be fed into ML model 120A for generating the structured instructions, as described herein.
AI engine 150A, such as when hosted by an external server.

Computing environment 104 may include and/or be in communication (directly and/or indirectly such as via client terminal(s) 108) with one or more physical user interfaces 124A-B that include provide a mechanism to enter data (e.g., into the chatbot 118) and/or view data (e.g., presented by the chatbot 118) for example, one or more of, a touchscreen, a display, gesture activation devices, a keyboard, a mouse, and voice activated software using speakers and microphone.

Referring now back to FIG. 2, at 202, one or more personal preference parameters for automated preparation of a dish by an automated cooking apparatus are obtained. Examples of personal preference parameter(s) includes: type of cuisine, allergy to at least one ingredient of the at least one dish, preference for a certain ingredient for inclusion in the at least one dish, dislike of the certain ingredient for exclusion from the at least one dish, amount of the certain ingredient to include in the at least one dish, compliance with dietary religious laws, and low calorie and/or low fat and/or low carbohydrate preference.

The personal preference parameter(s) may be received via an interactive chat session established between a chatbot and a client terminal. The personal preference parameter(s) may be of a user that is operating the client terminal, for example, for requesting preparation of the dish (e.g., for ordering by delivery) by the automated cooking apparatus.

The interactive chat session may be implemented within a web accessible graphical user interface (GUI), which may be presented on a display of the client terminal, and/or executed on the client terminal and/or on a server (e.g., remotely accessed by the client terminal such as via a web browser). The GUI may be designed for the user to enter data and/or make selections. For example, icons and/or images of different cuisines may be presented within the GUI, and the user may click on the icons and/or images for selection of a specific cuisine. In another example, the user may interact with the chatbot via the GUI using natural language typed by the user (e.g., via a keyboard) and/or spoken by the user (e.g., into a microphone).

The chatbot may be implemented as, for example, a machine learning model, optionally based on a generative language model. The chatbot may present questions, and/or request details, which serve as the personal preference parameter(s), and/or from which personal preference parameter(s) are extracted. For example, the chatbot may iteratively ask a series of questions to obtain sufficient number of personal parameters to enable creation of a customized dish for the user. Alternatively, the chatbot does need to obtain any preferences from the customer to suggest a dish. For example, the customer may type “suggest a dish” into the chatbot. In such a case, a dish may be selected, for example, randomly, and/or popular dishes that other customers ordered, and/or based on parameters obtained from other sources, such as dishes popular in the geographical region where the customer is located and/or dishes popular during the time of day that the customer is ordering.

Optionally, during a current iteration, the interactive chat session (e.g., the chatbot) presents a message for obtaining another personal preference parameter(s) according to an analysis of personal preference parameter(s) obtained in a preceding iteration. The questions may be asked, for example, based on a set of rules, and/or by the chatbot implemented as a trained ML model. For example, the chatbot may first ask for which cuisine type the user would like. The user may request vegan. In an following iteration, the chatbot asks “Do you have an allergy to food?”. In response to the user entering “Yes”, in a next iteration, the chatbot may ask for specific ingredients to which the user is allergic to which are found in vegan foods. For example, the chatbot may ask if there is an allergy to peanuts, but will not ask if there is an allergy to eggs or milk, since these ingredients are already excluded from vegan dishes.

Alternatively or additionally, or more of the personal preference parameters are obtained from a personal preference parameter dataset (e.g., repository), for example, personal preference parameters obtained from the same user during one or more prior interactive chat sessions and/or during prior preparations of dishes. For example, during a previous interactive chat session, the user entered an allergy to certain ingredients. The allergy was previously saved as a parameter, and used as a parameter in the current preparation of the dish.

Alternatively or additionally, or more of the personal preference parameters are obtained from one or more code sensors, for example, that analyze personal profile(s) of the user and/or data of the client terminal, for example, geographic location of the user, time of day, favorite foods previously discussed on a personal blog of the user, and the like.

As described herein, the personal preference parameter(s) may be obtained during one or more iterations in which the user interacts with the chatbot, such as by responding to questions of the chatbot. For example, in response to a question asked by the chatbot in response to an entry by the user in a previous iteration.

Optionally, the personal preference parameter(s) of a current iteration is an adaptation of the personal preference parameter(s) in a preceding iteration. For example, the user changes the value of the personal preference parameter(s) (e.g., from two teaspoons of sugar to one teaspoon of sugar), adds another value to the personal preference parameter(s) (e.g., previously requested adding ketchup to the hamburger, now added mayo), or cancels the previously provided personal preference parameter (e.g., change cuisine type from Chinese to Indian). As described herein, the structured instructions may be dynamically adapted for preparing an adaptation of the dish(es) according to the adaptation of the personal preference parameter(s).

Optionally, the personal preference parameter(s) is analyzed in view of the constraint parameter(s). The constraint parameter(s) may define constraints for preparation of the dish by the automated cooking apparatus. Examples of constraint parameter(s) includes one or more of: capability of the automated cooking apparatus (e.g., physical limitations of the apparatus), ingredients available for use by the automated cooking apparatus, cooking actions performed by the automated cooking apparatus, maximum time to prepare the dish by the automated cooking apparatus, and target range for cost for production of the dish by the automated cooking apparatus.

The analysis may be performed to determine whether the structured instructions that will be generated (e.g., as described herein) are predicted to comply with the constraint parameter. Other examples of analysis include: to determine whether the personal preference parameter(s) meets constraints defined by the constraint parameter(s), to determine whether the dish prepared by the automated cooking apparatus using automatically generated instructions (created based on the personal preference parameter(s)) meets the constraints, and/or to determine whether the automated cooking apparatus is physically able to meet the constraints.

In response to the analysis indicating that the constraint parameter is not met, the interactive chat session may be adapted for obtaining an adaptation of the personal preference parameter that meets the constraint parameter. For example, the chatbot indicates that the personal preference parameter does not meet the constraint parameter and requests another value. For example, chatbot indicates “Your request will result in a dish that will take too long to cook.”. The chatbot may suggest adaptations of the personal preference parameter to meet the constraint parameter.

At 204, one or more other parameter(s) are obtained.

The other parameter(s) may be obtained from one or more sensors, which may be physical sensors such as installed on the automated cooking apparatus (e.g., to monitor the cooking process, such as temperature, time, quality of the cooking), and/or code sensors (e.g., time and/or date of the chat session, geographic location of the client terminal participating in the chat session, and code for extracting prices of ingredients from data sources (e.g., commodity markets, websites of supermarkets)).

Sensor(s) may be installed within the automated cooking apparatus, to obtain one or more parameters. For example, to measure available ingredients, amount of ingredients, cooking times, and the like. Other examples of sensor(s) include code sensors which may automatically obtain one or more parameters, for example, a personal profile of the user, cost of ingredients, availability of ingredients, time of day, day of week, seasons of year, what certain eating habits entail (e.g., what religious law means, what foods are vegan), and the like.

Optionally, other parameters that are obtained include a current state of the automated cooking apparatus. For example, output of the sensors monitoring the automated cooking apparatus may indicate the performance ability of the automated cooking apparatus (e.g., mixing speed, speed of preparation of dish, number of different ingredients that may be used).

Other parameters may be obtained from datasets.

The other parameters may be analyzed in view of constraint parameter(s), as described herein.

The other parameters may include one or more dynamic parameters that vary over time. The dynamic parameter(s) may indicate a real time value (or near real time value) for a time interval. A current value of the dynamic parameter may correspond to a time interval of the interactive chat session. For example, availability of ingredients during the interactive chat session is evaluated. For example, some ingredients may be currently loaded into the automated cooking apparatus. When the user requests a certain ingredient that is not currently available, the chatbot may recommend an alternative ingredient that is available. In another example, the user may be using a mobile device to place the order while in a moving vehicle. When the geographical location of the user is out of bounds of delivery, the chatbot may indicate the delivery boundaries. The user may then indicate that they will be in the delivery boundary by the time that the dish is prepared.

Examples of dynamic parameter(s) that vary over time include: cost of ingredients used in preparation of the dish, availability of ingredients for preparation of the dish, time of day, day of week, season of year, and geographical location.

At 206, the parameters including the personal preference parameter(s) and/or dynamic parameter(s) may be fed into a machine learning model.

Exemplary architectures of the ML model include one or more (e.g., a pipeline) such as a combination of ML model components. For example, neural networks of various architectures (e.g., convolutional, fully connected, deep, encoder-decoder, recurrent, transformer, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning. Machine learning models may be trained using supervised approaches and/or unsupervised approaches. It is noted that non-ML models may be used, such as deterministic approaches, for example, sets of rules created by a domain expert.

Optionally, the machine learning model is trained on a training dataset of multiple records. A record may be created for a sample dish. The sample record includes multiple sample parameters, which may include personal preference parameters (or parameters suitable to be personal preference parameters) and/or dynamic parameters, and/or other parameters as described herein. The record may include a ground truth of structured instructions for execution by the automated cooking apparatus for automatically preparing the sample dish.

An exemplary approach for training the ML model is described, for example, with reference to FIG. 3.

At 208, structured instructions for execution by the automated cooking apparatus for automatically preparing at least one dish, are obtaining as an outcome of the machine learning model.

The structured instructions may be, for example, computer code, and/or code in human readable format, and/or code in non-human readable format (e.g., binary, electronic signals).

The structured instructions may define a sequence and/or a combination based on different actions and/or different features executed by different components of the automated cooking apparatus.

The structured instructions may comply with the personal preference parameter. Optionally, a setting may indicate whether the structured instructions are to fully comply with all personal preference parameters, or whether the structured instructions are to comply as best as possible with the personal preference parameters (e.g., optimal solution, best effort solution) without necessarily meeting all of the personal preference parameters. For example, ingredients requested by the user which are not available are substituted with available ingredients (e.g., using best substitutes).

The structured instructions for automatically preparing the dish(es) may be dynamically adapted according to the personal preference parameter(s) obtained via the interactive chat session. Optionally, the structured instructions are generated each iteration, or every few iterations, prior to terminal of the iterations. Dynamically generating the structured instructions during the iterations may enable, for example, using the structured instructions to dynamically create a rendering of what the dish prepared according to the structured instructions is predicted to look like, and/or may enable evaluation of the structured instructions before finalization such as to make sure that the structured instructions meet the constraint parameter(s). Alternatively or additionally, the structured instructions are generated upon termination of the iterations. Generating the structured instructions in response to terminal of the iterations, as opposed to during each iteration, may increase performance of the computing environment that generates instructions, for example, by reducing utilization of processing resources and/or reducing memory utilization of the computing environment.

The structured instructions may be for operating one or more components of the automated cooking apparatus, at one or more settings. For example, when the automated cooking apparatus is implemented as a robotic kitchen designed to perform multiple different actions on multiple different ingredients for preparation of multiple different dishes, the structured instructions may be for operating components at different settings for performing different actions, for example: adding a predefined measure of a certain ingredient, cutting, mixing, stirring, and cooking.

The structured instructions may be based the different ingredients for preparation of the dish.

At 210, the interactive chat session may be updated (e.g., the GUI presenting the interactive chat session may be updated) and/or additional feature(s) may be implemented.

Optionally, the structured instructions are converted into human readable form. The human readable form may be presented on the display of the client terminal, for example, within the GUI. For example, the structured instructions may be converted from code into bullet form and/or paragraph form, to help the user understand how the dish is to be prepared. For example, the structured instructions may be converted into a recipe format, that includes a list of ingredients, and a set by set human readable form of the instructions of how the dish is to be prepared, such as mix ingredients A and B, add ingredient C, and cook at 200 degrees Celsius for 30 minutes. The human readable form may exclude details which are specific to the automated cooking apparatus but irrelevant to a human preparing the dish, for example, RPM of the mixing component.

Alternatively or additionally, a customized menu is dynamically created and presented within the GUI presented on the display of the client terminal. The customized menu may be automatically created based on the generated structured instructions, optionally per iteration and/or after one or more iterations in which personal preference parameter(s) are dynamically provided. The customized menu may include one or more customized dishes that may be created by the automated cooking apparatus executing the generated structured instructions. The GUI may be designed for ordering one or more of the customized dishes from the menu via the client terminal. For example, the user selects the customized dish(es) (e.g., by clicking) and orders the selected dishes for delivery. The customized menu may be dynamically adapted during iterations, in response to dynamically provided personal preference parameter(s).

Alternatively or additionally, a landing webpage that includes the GUI of the customized menu may be dynamically created. The landing webpage may be automatically created in a format for being hosted by a web server accessible by multiple client terminals. The landing webpage may enable other users using other client terminals to order their preferred dishes from the customized menu. For example, a set of customized dishes selected for a wedding may be used as the basis for creation of the customized menu. Individuals attending the wedding may access the landing page for selecting their meals during the wedding from the customized menu, for example, in real time using their mobile devices. The selected dishes may then be locally prepared automatically by the automated cooking apparatus located in the kitchen of the wedding hall.

Optionally, one or more image representing a visual prediction of the dish after preparation by the automated cooking apparatus (according to the structured instructions based on the parameters including the personal preference parameters) may be generated. The image(s) may be dynamically presented on the display of the client terminal, for example, within the GUI. The image may be dynamically updated in response to dynamically provided and/or dynamically adapted personal preference parameter(s). The dynamic update of the image predicting what the dish will look like in response to dynamically adapted personal preference parameters may enable the user with customization of the dish. For example, the user may change the personal preference parameter(s), and view the predicted resulting dish, to help select the personal preference parameter(s) to obtain the desired dish.

The image of the predicted dish may be generated by the following exemplary process. Features may be extracted from the structured instructions for preparation of the dish. Features may be extracted from other sources, for example, from the parameters fed into the ML model, including the personal preference parameter(s) and/or dynamic parameter(s). The extracted features may be, for example, hand crafted features, features automatically found by a feature mining process (e.g., features best correlated with a target outcome), and/or features automatically extracted by a neural network (e.g., the structured instructions are fed into the neural network). The features may be fed into an automated image generation model for automatically generating the image predicting what the dish will look like upon preparation by the automated cooking apparatus. The automated image generation model may be, for example, implemented as a generative adversarial network (GAN). The automated image generation model may be trained from a training dataset of records, where a record includes sample structured instructions (and/or features extracted therefrom) and a ground truth of an actual image of the actual dishes created by the automated cooking apparatus executing the sample structured instructions.

At 212, one or more features described with reference to 202-210 may be iterated. During the iterations, additional personal preference parameter(s) may be obtained via the chatbot and/or personal preference parameter(s) may be adapted, optionally sequentially and/or in response to personal preference parameter(s) provided by the user in preceding iteration(s).

The iterations may terminate, for example, upon the user manually providing an input indicating termination (e.g., user is satisfied with the dish that will be created, optionally in response to viewing a rendered image predicting what the dish will look like), and/or convergence of the parameters fed into the ML model. Convergence of parameters may be determined, for example, when no more relevant parameters remain for being selected by a user while meeting constraints of other parameters. For example, the users has been through a certain sequence of iterations for collecting the relevant personal preference parameter(s) for generating a specific dish, which are relevant for the particular sequence for the specific dish (since not all personal preference parameters are relevant to all dishes). Alternatively or additionally, convergence may be determined when a number of different candidate dishes that may be generated from the set of personal preference parameters is less than a threshold, and/or diversity of dishes is less than a requirement (e.g., threshold). In other words, diversity may be determined when the set of parameters result in dishes that are similar to one another without being very significantly different. Convergence may be determined when additional iterations are not predicted to significantly further produce unique dishes. For example, pasta dishes with small differences between then may be generated, such as different amounts of salt, and/or different amount of cheese. Since the user may add salt and/or cheese, further iterations may not necessarily be helpful. The differences between dishes may be computed, for example, by a correlation between the dishes (e.g., between the images and/or between the structured instructions). When the correlation is above a threshold, the dishes may be determined to be similar.

During each subsequent iteration, the chatbot may generate messages (e.g., questions, requests for information) designed to focus the candidate dishes that may be produced from the previously collected personal preference parameters to a smaller number of candidate dishes and/or smaller diversity between the dishes, optionally in comparison to a preceding iteration. The candidate dishes may be the possibility of dishes that may be created based on the structured instructions and/or from different possible structured instructions that may be generated by the ML model in response to being fed the personal preference parameter(s) obtained until the current iteration.

Alternatively or additionally, the personal preference parameter(s) of a current iteration is generated for providing another possible option of a variation of the dish, which was not necessarily provided in a preceding iteration. For example, another ingredient to add, a selected cooking operation (e.g., mix pasta with vegetable, or layer vegetables above the pasta).

Alternatively or additionally, a new record may be created for updating the ML model. The new record may be created using the personal preference parameter(s) and/or other parameters, with the ground truth of the generated structured instructions. Optionally, feedback obtained from the user which ordered the customized dish may be included in the record. The feedback may be obtained by sending a message to the client terminal and/or via the GUI. For example, a rating of the dish may be included. The rating may include at least a high rating indicating a tasty and/or high quality dish. A lower rating may indicate a less tasty and/or lesser quality dish. The rating may be implemented as, for example, a binary value (e.g., tasty, not tasty), category (e.g., tasty, OK, poor taste), and/or a number (e.g., from 1 to 10 indicating taste and/or quality). The rating may help train the ML model to generate structured instructions for preparing dishes likely to be rated high, while reducing or avoiding structured instructions for preparing dishes likely to be rated lower.

At 214, the structured instructions may be provided for execution by the automated cooking apparatus for automatically preparing the dish(es). Optionally, the structured instructions are provided in response to an indication received from the client terminal, for example, the user has used the GUI presented on the display of the client terminal to order the dish.

The structured instructions may be, for example, transmitted to the automated cooking apparatus, forwarded to a remote device (e.g., which may forward the structured instructions to the automated cooking apparatus), stored on a data storage device, and/or fed into another process.

At 216, the dish(es) may be automatically prepared by the automated cooking apparatus executing the structured instructions. The prepared dish may be provided to the user, for example, via an order delivery service.

Referring now back to FIG. 3, multiple sample parameters associated with a sample dish which may be automatically prepared by an automated cooking apparatus, are obtained.

The sample parameters may be obtained, for example, from sensors (e.g., code sensors, physical sensors associated with the automated cooking apparatus), manually entered by a user (e.g., chef and/or operator that manually design recipes and/or manually operate the automated cooking apparatus), and/or from datasets (e.g., previously collected parameters which were saved in the datasets).

The sample parameters may include personal preference parameter(s) and/or parameters suitable to be personal preference parameter(s). For example, a type of sauce in a pasta dish is obtained. For the sample dish, the type of sauce may not have been necessarily selected by a user, but may have been determined as a pre-defined setting. However, the type of sauce may be suitable for use as a personal preference parameter (as described herein), in the sense that a user may select which type of sauce they would like for a customized dish.

The sample parameter(s) may include parameter(s) indicating capability of the automated cooking apparatus, for example, as described herein.

The sample parameter(s) may include constraint(s) for preparing the sample dish, for example, as described herein.

The sample parameter(s) may include dynamic parameter(s), optionally with a time interval, for example, as described herein.

The sample parameter(s) may include other parameters, for example, as described herein.

At 304, structured instructions which may be executed by the automated cooking apparatus for preparing the sample dish, are obtained.

The structured instructions may be manually generated, for example, by an operator (e.g., chef) that uses domain knowledge of cooking to manually define how to create the dish by operating different components of the automated cooking apparatus.

Alternatively or additionally, the structured instructions may be automatically generated, for example, by the ML model described herein. In such a case, the features described with reference to FIG. 3 may be used for creating records for updating the ML model, for example, as described herein.

At 306, a record may be created. The record may include the parameters associated with the sample dish, including the personal preference parameter(s). The record may include other parameters, such as the dynamic parameter(s) and/or the indication of the time interval associated with the dynamic parameter(s). The record may further include a ground truth of the structured instructions executed by the automated cooking apparatus for preparing the sample dish.

At 308, one or more features described with reference to 302-306 may be iterated, for creating multiple records for multiple sample dishes which may be automatically prepared by the automated cooking apparatus.

At 310, a training dataset that includes the multiple records may be created. One or more training datasets may be created, for example, to train more specific and/or focused ML models. For example, a training dataset may be created per type of automated cooking apparatus, using parameters which may be specific to the type of automated cooking apparatus. In another example, different training datasets may be created for different geographical locations, representing different local cuisine cultures.

At 312, the machine learning model may be trained (and/or updated) on the records (e.g., the training dataset). Optionally, multiple ML models are trained on the multiple training datasets.

Referring now back to FIG. 4, GUI 402 may include one or more windows 404 for interaction with the chatbot in multiple iterations, as described herein. For example, chatbot may present a list of available ingredient, followed by a request for more information, such as to obtain a personal preference parameter. The user may respond (appearing in bold), for example, requesting an Asian recipe, as shown. The cuisine type of Asian recipe may be used as the personal preference parameter(s), as described herein. An exemplary recipe 406 may be presented, for example, by feeding the personal parameter(s) and/or other parameters into the ML model, obtaining the structured instructions, and converting the structured instructions to human readable format, in the form of recipe 406. GUI 402 may further include an order summary window 408, which may indicate the dishes and/or other items that are being ordered. GUI 402 may further include icon(s) 410 for selecting delivery or pickup of the prepared dish(es). GUI 402 may further include an image 412 representing a prediction of what the selected dish (e.g., Chinese lemon chicken) will look like, which may be generated by a GAN based on the recipe and/or structured instructions, as described herein.

Referring now back to FIG. 5, GUI 502 may include one or more windows 504 for interaction with the chatbot in multiple iterations, as described herein. For example, chatbot may request input from a user. The user may request a recipe popular in Florida (appearing in bold). The popular recipe in Florida may be used as the personal preference parameter(s) described herein. The chatbot may recommend Key West shrimp and gritts. GUI 502 may further include an image 506 representing a prediction of what the proposed dish (e.g., Key West shrimp and gritts) will look like, which may be generated by a GAN based on the structured instructions and/or personal preference parameter(s), as described herein. An exemplary description 508 of the ingredients included in the dish and/or how the dish is prepared may be presented, for example, by feeding the personal parameter(s) and/or other parameters into the ML model, obtaining the structured instructions, and converting the structured instructions to human readable format, as described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant automated cooking apparatuses will be developed and the scope of the term automated cooking apparatus is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of operating an automated cooking apparatus, comprising:
in at least one iteration:
receiving, via an interactive chat session between a chatbot and a client terminal, at least one personal preference parameter for automated preparation of a dish by the automated cooking apparatus;
feeding a plurality of parameters including the at least one personal preference parameter into a machine learning model; and
obtaining as an outcome of the machine learning model, structured instructions for execution by the automated cooking apparatus for automatically preparing at least one dish, wherein the structured instructions comply with the at least one personal preference parameter;
wherein the structured instructions for automatically preparing the at least one dish are dynamically adapted according to the at least one personal preference parameter obtained via the interactive chat session.

2. The computer implemented method of claim 1, wherein during the at least one iteration, receiving comprises receiving an adaptation of at least one personal preference parameter provided in a preceding iteration, and dynamically adapting the structured instructions for preparing an adaptation of the at least one dish according to the adaptation of the at least one personal preference parameter.

3. The computer implemented method of claim 1, wherein the plurality of parameters include at least one constraint parameter for preparation of the at least one dish, wherein the structured instructions comply with the at least one constraint parameter, and further comprising:
analyzing the at least one personal preference parameter in view of the at least one constraint parameter; and
in response to the analysis indicating that the at least one constraint parameter is not met, adapting the interactive chat session for obtaining an adaptation of the at least one personal preference parameter that meets the at least one constraint parameter.

4. The computer implemented method of claim 3, wherein the at least one constraint includes at least one of: capability of the automated cooking apparatus, ingredients available for use by the automated cooking apparatus, cooking actions performed by the automated cooking apparatus, maximum time to prepare the at least one dish by the automated cooking apparatus, and target range for cost for production of the at least one dish by the automated cooking apparatus.

5. The computer implemented method of claim 1, wherein the at least one personal preference parameter includes at least one of: type of cuisine, allergy to at least one ingredient of the at least one dish, preference for a certain ingredient for inclusion in the at least one dish, dislike of the certain ingredient for exclusion from the at least one dish, amount of the certain ingredient to include in the at least one dish, compliance with dietary religious laws, and low calorie and/or low fat and/or low carbohydrate preference.

6. The computer implemented method of claim 1, wherein during a current iteration, the interactive chat session presents a message for obtaining another at least one personal preference parameter according to an analysis of at least one personal preference parameter obtained in a preceding iteration.

7. The computer implemented method of claim 1, wherein the at least one iteration terminates upon at least one of: user input indicating termination, and convergence of the plurality of parameters.

8. The computer implemented method of claim 7, wherein convergence comprises at least one of: no more remaining parameters for selection by a user while meeting constraints of other parameters, generating a number of dishes less than a threshold, and diversity of dishes being less than a threshold.

9. The computer implemented method of claim 1, wherein the at least one personal preference parameter of a current iteration is selected for at least one of: providing another possible option of a variation of the at least one dish, reducing the number of dishes, and reducing diversity of the dishes, generated by the machine learning model in comparison to a preceding iteration.

10. The computer implemented method of claim 1, further comprising converting the structured instructions into human readable form, and presenting the human readable form on a display of the client terminal.

11. The computer implemented method of claim 1, wherein the plurality of parameters that are fed into the machine learning model include at least one dynamic parameter indicating a real time value for a time interval.

12. The computer implemented method of claim 1, further comprising, during the at least one iteration:
obtaining structured instructions for a plurality of dishes as the outcome of the ML model; and
dynamically adapting a customized menu presented within a web accessible graphical user interface (GUI) presented on a display of a client terminal, the GUI configured for ordering at least one dish of the plurality of dishes from the menu via the client terminal.

13. The computer implemented method of claim 12, further comprising automatically creating a landing webpage that includes the GUI of menu for hosting by a web server accessible by a plurality of client terminals.

14. The computer implemented method of claim 1, further comprising, during the at least one iteration:
extracting a plurality of features from the structured instructions for preparation of the at least one dish;
feeding the plurality of features into an automated image generation model for automatically creating at least one image representing a visual prediction of the at least one dish after preparation by the automated cooking apparatus; and
dynamically updating the automatically created image according to the at least one personal preference parameter.

15. The computer implemented method of claim 1, wherein the machine learning model is trained on a training dataset comprising a plurality of records, wherein a record comprises a sample plurality of parameters, and a ground truth of structured instructions for execution by the automated cooking apparatus for automatically preparing at least one sample dish.

16. The computer implemented method of claim 15, wherein the sample plurality of parameters include sample values for at least one personal preference parameter.

17. The computer implemented method of claim 1, wherein the plurality of parameters include at least one dynamic parameter that varies over time, wherein a current value of the at least one dynamic parameter corresponding to a time interval of the interactive chat session is fed into the machine learning model.

18. The computer implemented method of claim 17, wherein the at least one dynamic parameter includes at least one of: cost of ingredients used in preparation of the at least one dish, availability of ingredients for preparation of the at least one dish, time of day, day of week, season of year, and geographical location.

19. The computer implemented method of claim 1, wherein the automated cooking apparatus comprises a robotic kitchen configured to perform a plurality of different actions on a plurality of different ingredients for preparation of a plurality of different dishes, the plurality of different actions selected from: adding a predefined measure of a certain ingredient, cutting, mixing, stirring, and cooking, wherein the structured instructions define a sequence and/or a combination based on the plurality of different actions and based on the plurality of different ingredients for preparation of the at least one dish.

20. The computer implemented method of claim 1, further comprising
in response to instructions received from the client terminal, providing the structured instructions for execution by the automated cooking apparatus for automatically preparing the at least one dish.

21. The computer implemented method of claim 20, further comprising:
automatically preparing the at least one dish by the automated cooking apparatus executing the structured instructions.

22. The computer implemented method of claim 1, further comprising:
obtaining feedback from the user indicating a rating of the at least one dish automatically prepared by the automated cooking apparatus executing the structured instructions;
automatically creating a new record including the plurality of parameters including the at least one personal preference, a ground truth of the structured instructions obtained as the outcome of the machine learning model, and the rating; and
updating the machine learning model for creating structured instructions for preparing dishes likely to be associated with a high rating.

23. A computer implemented method of training a machine learning model, comprising:
for each sample dish of a plurality of sample dishes automatically prepared by an automated cooking apparatus:
obtaining a plurality of parameters including at least one personal preference parameter;
creating a record comprising the plurality of parameters and a ground truth including structured instructions executed by the automated cooking apparatus for preparing the sample dish; and
training the machine learning model on a plurality of records for the plurality of sample dishes.

24. The computer implemented method of claim 23, wherein the record further comprises at least one dynamic parameter and an indication of the time interval.

25. The computer implemented method of claim 23, wherein at least one parameter of the plurality of parameters of the record indicates capability of the automated cooking apparatus.

26. The computer implemented method of claim 23, wherein at least one parameter of the plurality of parameters of the record indicates at least one constraint for preparing the sample dish.

27. A system for operating an automated cooking apparatus, comprising:
at least one processor executing a code for:
in at least one iteration:
receiving, via an interactive chat session between a chatbot and a client terminal, at least one personal preference parameter for automated preparation of a dish by the automated cooking apparatus;
feeding a plurality of parameters including the at least one personal preference parameter into a machine learning model; and
obtaining as an outcome of the machine learning model, structured instructions for execution by the automated cooking apparatus for automatically preparing at least one dish, wherein the structured instructions comply with the at least one personal preference parameter;
wherein the structured instructions for automatically preparing the at least one dish are dynamically adapted according to the at least one personal preference parameter obtained via the interactive chat session.
